(19) United States
(12) Patent Application Publication
(10) Pub. No.: US 2013/0205960 A1
(43) Pub. Date: Aug. 15, 2013

(54) METHOD FOR OPERATING A SLICING DEVICE WITH MULTI-LANE DRIVES

(71) Applicant: Jörg Schmeiser, Wiggensbach (DE)

(72) Inventor: Jörg Schmeiser, Wiggensbach (DE)

(73) Assignee: CFS BUHL GMBH, Kempten, DE (DE)

(21) Appl. No.: 13/695,691

(22) PCT Filed: May 3, 2011
(86) PCT No.: PCT/EP2011/002190

§ 371 Date: Dec. 21, 2012

(30) Foreign Application Priority Data
May 3, 2010 (DE) 10 2010 019 248.1

(51) Int. Cl. B26D 7/06

(52) U.S. Cl. CPC B26D 7/0633
USPC 83/23

(57) ABSTRACT

The present invention relates to a method for slicing at least one food bar by means of a slicing device, in which method at least one food bar in in each case one lane is transported by means of in each case one transport means in the direction of a cutting blade which is driven in rotation and which, in a cutting plane at the front end of the food bar, severs food slices from the food bar, which food slices are combined into portions and transported away, wherein in order to generate the portion or transport the portion away, the cutting blade performs unproductive cuts during which the cutting blade is moved but no food slices are severed from the food bar.

The present invention relates to a method for slicing at least one food bar, having a slicing device in which at least one food bar is transported in in each case one lane toy way of in each case one transporting means in the direction of a rotationally driven cutting blade Which cuts off food slices from the food bar in a cutting plane at the front end of the rood bar, said food slices being combined into portions and transported away, wherein, in order to produce the portion and/or to transport the portions away, the cutting blade carries out unproductive cuts, in which the cutting blade moves but no food slices are cut off from the food bar.

A method of this kind is known from the prior art but has the drawback that, in particular in the case of the multi-lane slicing of very long, heavy food bars, shred formation repeatedly occurs. Furthermore, the methods according to the prior art are not flexible enough and/on the food bar is exposed to pronounced accelerations.

In was therefore the object of the present invention to provide a method which does not have the drawbacks of the prior art.

The object is achieved by a method for slicing at least one food bar, having a slicing device in which at least one food bar is transported in in each case one lane by way of in each case one transporting means in the direction of a rotationally driven cutting blade which cuts off food slices from the food bar in a cutting plane at the front end of the food bar, said food slices being combined into portions and transported away, wherein, in order to produce the portion and/or to transport the portions away, the cutting blade carries out unproductive cuts, in which the cutting blade moves but no food slices are cut off from the food bar, and wherein, in order to carry out the unproductive cuts, the cutting blade and at least the front end of the food bar are moved away from one another.

The statements made for this subject of the present invention apply in equal measure to the other subjects of the present invention, and vice versa.

The present invention relates to a method for slicing a food bar by way of a slicing device. Such a slicing device is preferably what is known as a slicer, in particular a high-performance slicer, in which for each food bar more than six hundred, sometimes more than a thousand food slices are cut off per minute. In such a slicing device, one food bar, but preferably a plurality of food bars, for example sausage, cheese or ham bars, are transported continuously or intermittently by a transporting belt in the direction of a rotationally driven cutting blade which cuts off food slices from the food bar in a cutting plane at the front end of the latter. The cutting blade can be for example a circular blade or crescent blade. The food slices are portioned on a portioning means, for example a portioning belt or portioning table, into portions consisting of a plurality of, for example ten, food slices, and then transported away as portions. A plurality of portions can be produced simultaneously on the portioning means and transported away. Since, as is known, the frequency of the cut-off food slices are too high for portioning and/or transporting away, it is frequently necessary to carry out unproductive cuts, in which the blade continues to carry out its normal movement, for example its rotational movement, but no food slices are cut off from the food bar.

According to the invention, these unproductive cuts are achieved in that the cutting blade is pulled away from the front end of the food and out of the cutting plane and at least the front end of the food bar is moved away from the cutting plane. Both the cutting blade and the front end of the food bar consequently perform a movement which increase the distance between the cutting blade and the front edge of the food bar. Preferably, both the movement of the cutting blade and that of the food bar are provided in a linear manner, very particularly preferably in a manner parallel to one another. Preferably, the cutting blade is displaced along or parallel to its rotation axis. The pull-back movement of the front end of the cutting blade can take place by the entire food bar being pulled back and/or by the front end of the food bar being compressed. The food bar and/or a part of the food bar is moved preferably together with its support, for example a transporting belt.

Preferably, the movement of the cutting blade begins before the movement of the front end of the food bar is started. This preferred embodiment of the present invention has the advantage that more time is available for the at least portionwise movement of the food bar, without shreds being formed. As a result, the food bar or parts of the food bar has or have to be accelerated to a less pronounced extent, and so the forces to be applied are smaller and/or vibrations of the food bar and/or of the entire device are at least reduced.

Preferably, a plurality of food bars are sliced at least occasionally at the same time.

A further subject of the present invention is a method for slicing food bars by way of a slicing device which has multiple lanes, into which in each case one food bar is loaded and transported independently of the other lane or lanes in the direction of the rotationally driven cutting blade which cuts off food slices in a cutting plane at the front end of the particular food bar, said food slices being combined into portions and transported away. According to the invention, it is now provided that, during the cutting movements for slicing a complete portion, the same number of food slices is not cut off for all food bars and/or at least occasionally different food bars are sliced.

The statements made for this subject of the present invention apply in equal measure to the other subjects of the present invention, and vice versa.

According to the invention, it is consequently provided that, during at least one cutting movement of the cutting blade, which is necessary for slicing a portion, a slice is cut off from at least one food bar, while no food slice is cut off from another food bar which is likewise located in the slicing device. As a result, it is possible to produce a portion having different food slices, for example sausage and cheese, with the sausage slices being cut off at least to some extent before the cheese slices or vice versa. Furthermore, it is possible to vary the number of each particular food slice per variety. For example, it is possible for one portion to have five slices of sausage and only three slices of cheese, although the food slices for one portion are cut off in one device.

In a preferred embodiment, this is achieved in that the number of unproductive cuts per lane and/or the transport of the particular food bar per lane is selected individually. In the lanes in which no food slices are intended to be cut off, the particular food bar is pulled away from the cutting plane and the forward feed is shut down. In this lane, the cutting blade consequently performs unproductive cuts, while food slices are cut off from another food bar in at least one other lane.

Moreover, it is possible with the method according to the invention to slice a plurality of portions at the same time, in which the products are arranged in a plurality of rows, with the spacing of the food slices on the portioning means preferably being smaller than the spacing of the food bars and/or in which at least two different products are present in one portion.

Preferably, in order to carry out an unproductive cut, the cutting blade and/or to at least the front end of the particular food bar are moved away from one another.

Preferably, for one portion, food slices are cut off from a plurality of food bars, wherein the number of food slices per food bar is different, but wherein during the last cutting movement for each particular portion a slice is cut off from all food bars located in a lane.

According to a further or a preferred subject of the present invention, the fond bars are each grasped by a gripper at different times at that end of the food bar that is remote from the front.

The statements made for this subject of the present invention apply in equal measure to the other subjects of the present invention, and vice versa.

The gripper has in particular the function of stabilizing the food bar, when it has already been largely sliced, in its position during further slicing, so that it does not tilt, and/or of pulling what is known as the oddment, which cannot be sliced, away from the cutting blade and removing it from the particular lane, for example discarding it into a container or the like.

This embodiment of the method according to the invention allows great flexibility in particular when each particular food bar has a different length and/or when they are sliced at different rates.

Since for each food bar, as a rule, there remains an unsliced end piece which is pulled back in each case by the gripper, this pull-back takes place in each particular lane according to the invention or preferably at least to some extent at different times.

Preferably, the grippers of all lanes are mounted in a movable manner on a single central unit and are preferably guided thereby. Preferably, each gripper has a separate drive, by way of which it is possible to move this gripper individually, i.e. independently of the other grippers, to at least along a certain path length in relation to the central unit. Preferably, the grippers can be transferred from a gripping state into a nongripping state, particularly preferably in each case individually.

Preferably, the central unit is likewise provided to be movable along the slicing device.

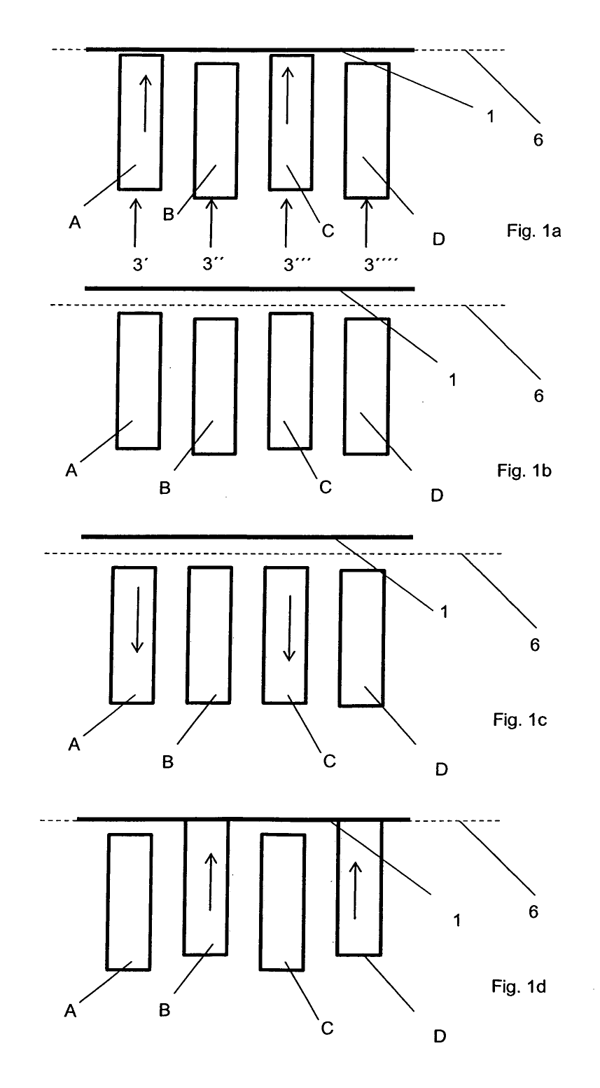

The inventions are explained in the following text with reference to FIGS. 1-6. These explanations are merely by way of example and do not limit the general concept of the invention. These explanations apply in equal measure to all subjects of the present invention.

FIG. 1a-d shows a first embodiment of the method according to the invention.

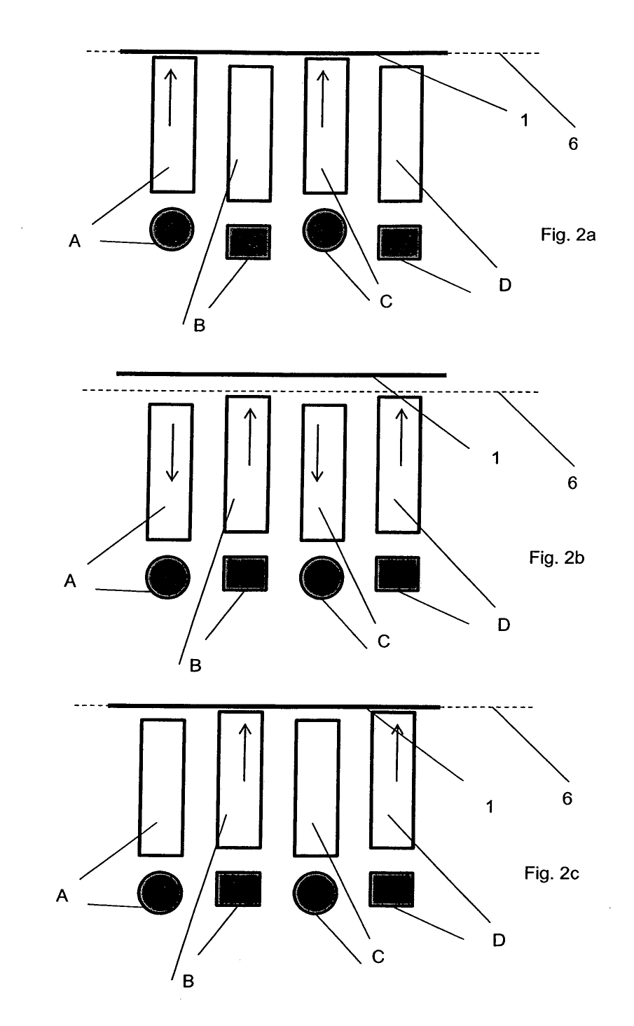

FIG. 2a-c shows a further embodiment of the method according to the invention, in which different types of food bars are sliced for one portion.

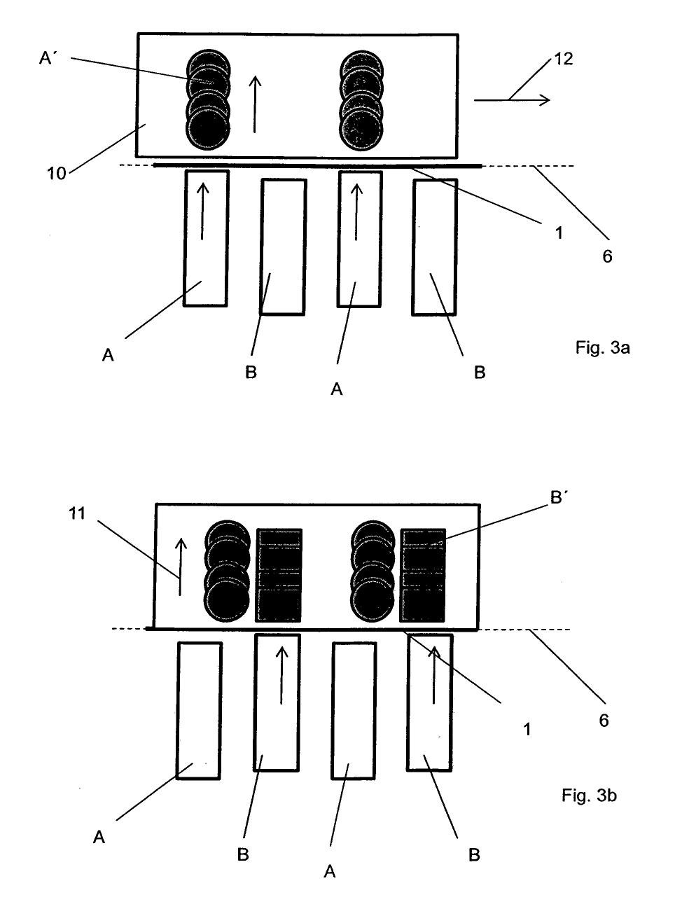

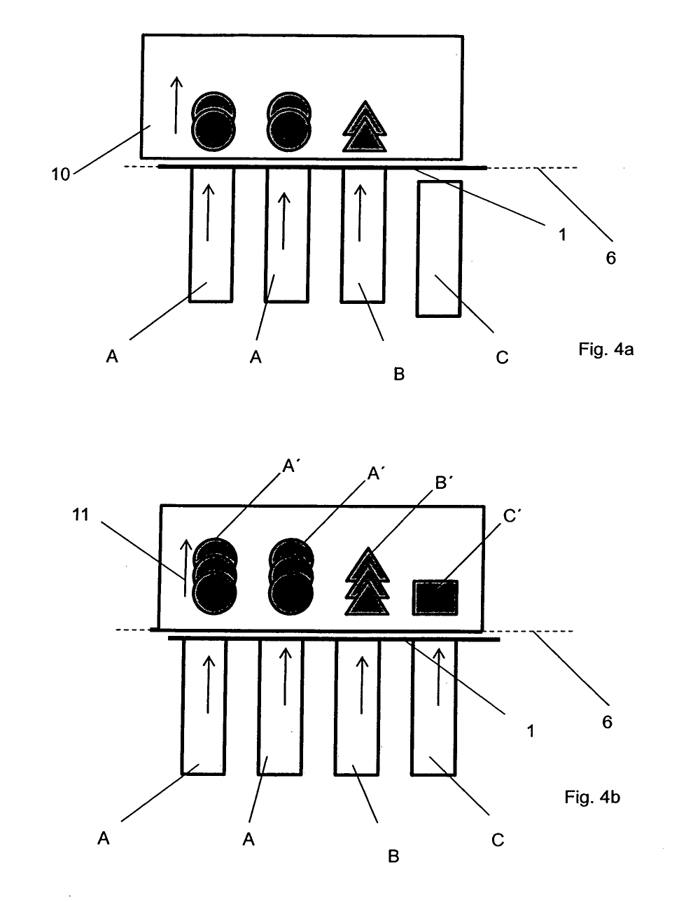

FIG. 3a, b shows an embodiment of the method according to the invention, in which one food portion has different varieties of food slices.

FIG. 4a, b shows an embodiment of the method according to the invention, in which a different, number of food slices are cut off per food bar for one portion.

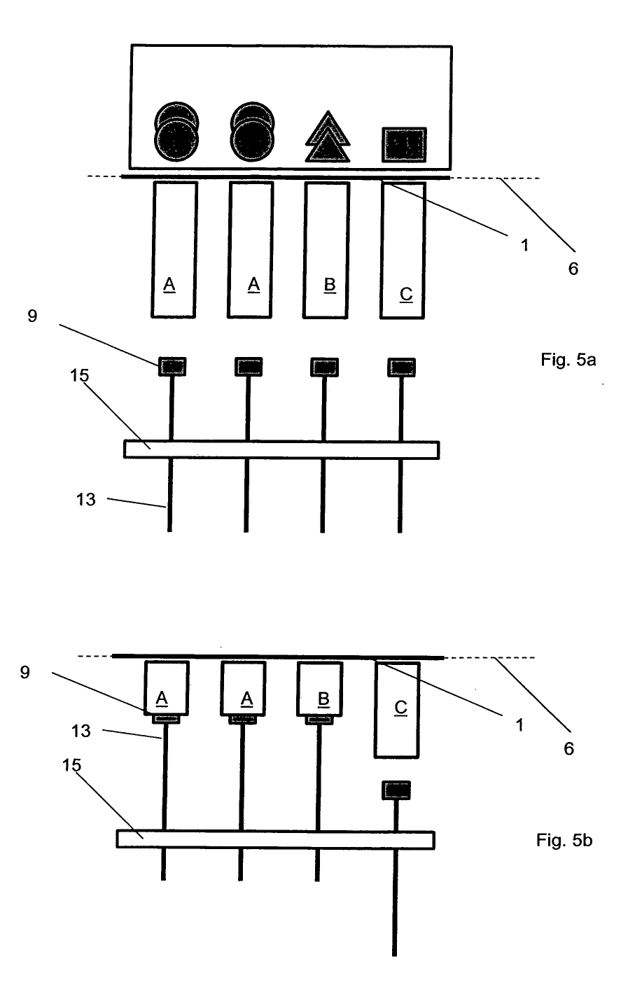

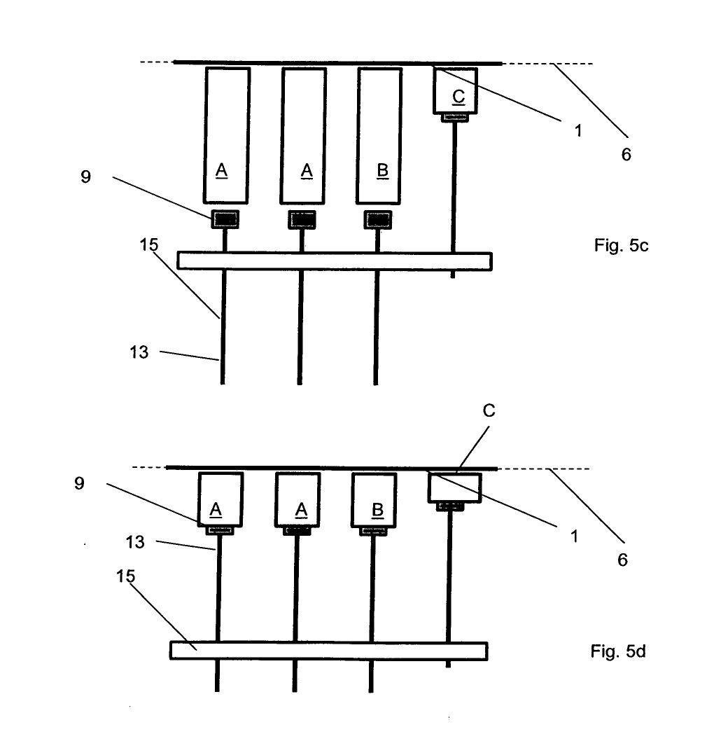

FIG. 5a-d shows the movement or the grippers during the multi-lane slicing of food bars.

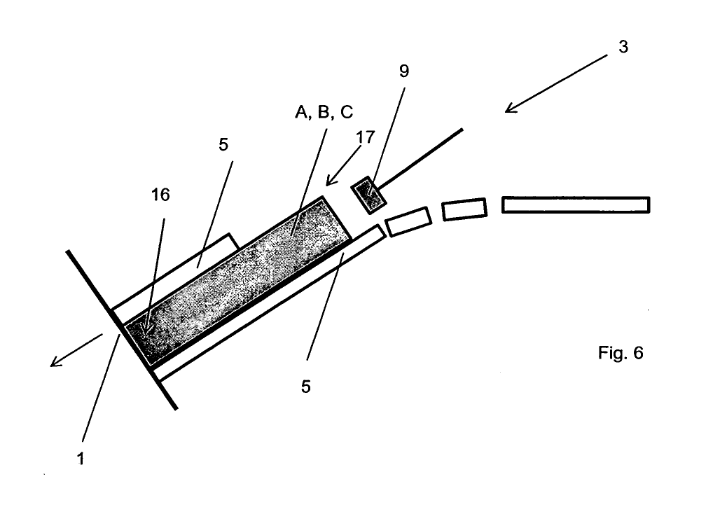

FIG. 6 shows an embodiment of a lane of a slicing device.

FIG. 1 shows a first embodiment of the method according to the invention. This method is carried out with a four-lane slicing device, in which four food bars A-D can be transported independently of one another by way of in each case one transporting means (not illustrated) in the direction of a cutting blade 1 which can cut off food slices from the front end of each particular food bar in the cutting plane 6. A person skilled in the art will understand that the slicing device can have more or fewer lanes 3′-3″″, but, for example, also only one lane. The cutting blade 6 is preferably driven in rotation. In the illustration according to figure a the food bars B and D are in a pulled-back position, in which the forward feed of the transporting means of each particular lane 3″, 3″″ is not activated. However, the food bars A and C, as illustrated in each case by the arrow within the food bar, are transported continuously or intermittently in the direction of the food bar, such that the cutting blade 1 cuts off in each case one food slice (not illustrated) from the front end of the food bars A and C in the cutting plane 6 upon each rotation. If the food bar to be sliced is intended to be changed, this is preferably carried out as illustrated in FIGS. 1b to d. For this purpose, according to the invention both the cutting blade 1 is moved away from the cutting plans 6 and from the front end of the food bars, as illustrated in FIG. 1b, and, as illustrated in FIG. 1c, the food bar that is being sliced, in this case A and C, is pulled back a little from the cutting plane 6. Since the cutting blade 1 was moved away from the cutting plane 6 first of all, more time is available fur the pull-back movement of the food bars A and C than the normal time window for a complete movement, for example a rotary or planetary movement, and so said food bars do not have to be pulled back within a rotation of the cutting blade or less, without shred being formed, but instead more time is available. In the illustrations according to FIGS. 1b and c, the cutter performs unproductive cuts, i.e. it rotates without food slice being cut off from the food bars. Then (cf. FIG. 1d), the cutting blade 1 is moved back into the cutting plane and then the food bars B and D are transported in the direction of the cutting blade such that the cutting blade cuts off food slices from these bars. By way of the method according to the invention, it is possible to load a plurality of lanes with food bars and not always to cut off slices from all food bars upon each movement of the blade. Furthermore, it is possible with the method according to the invention to vary slicing between the particular food slices and/or to cut off a different number of food slices from each particular food bar. FIG. 1 also serves as an illustration when only one food bar in one lane is sliced. In this case, too, in order to carry out unproductive cuts, both the cutting blade 1 is moved away from the cutting plane 6 and to at least the front end of the food bar A is pulled back from the cutting plane. This embodiment, when only one food bar is sliced, has the advantage that the movement of the food bar can take place more slowly and/or that no shreds are formed even when the slicing process is interrupted for a relatively long time.

FIG. 2 shows substantially the method according to FIG. 1. In the present case, the slicing machine likewise has four lanes 3′- 3″″, wherein two lanes 3′, 3′″ are each loaded with a food bar having a round cross section and two lanes 3″, 3″″ are each loaded with a food bar having a square cross section. In the illustration according to FIG. 2a, the food bars having the round cross section are sliced until a sufficient number of food slices having a round cross section have been sliced. Then, as is illustrated in FIG. 2b, the cutting blade 1 is moved back from the cutting plane 6 by a linear distance, the bars in the lanes 3′, 3′″ are pulled back and the bars B and D having the square cross section are pushed forward. Subsequently, or at the same time, the cutting blade 1 is moved back into the cutting plane 6 again (FIG. 2c) and the slicing of the bars B and D can begin, in that they are transported in the direction of the cutting blade. A person skilled in the art will see that the pulling back of the bars A and C and the pushing forward of the bars B and D can take place in succession or at the same time. However, the pulling back of the food bars which have just been sliced preferably takes place after the cutting blade has been pulled away from the cutting plane. A person skilled in the art will understand that the method illustrated here can also be carried out without the cutting blade being pulled back out of the cutting plane.

FIG. 3 shows a further embodiment of the method according to the invention, for example of the method according to FIG. 2a. Once again, four food bars in four lanes are sliced and the food slices are deposited, in this case in a staggered manner, on a portioning table 10, for example an X/Y table. However, there could, for example, also be only two lanes. The food bars A have a round cross section and the food bars B a square cross section. In the present case, two portions are sliced at the same time. First of all, as illustrated in FIG. 3a, the food bars A are sliced, wherein after each slice, as illustrated by the arrow on the portioning table 10, the latter is moved forward by a certain distance in order to achieve a staggered portion. The food bars B are located in this case in a pulled-back position. Then, preferably the cutting blade 1 is displaced by a linear distance from the cutting plane 6 in the direction of the cutting table, so that it performs unproductive cuts. Furthermore, the portioning table, as illustrated by the arrow 12, is moved a certain distance to the right. Furthermore, as illustrated in FIG. 3b, the food bars A are pulled back and the food bars B pushed forward. Moreover, preferably the portioning table 10 is pushed in the direction of the food bars again. Then, the transporting belts transport the food bars B in the direction of the cutting blade, which cuts off food slices therefrom, said food slices being deposited in a staggered manner on the portioning table 10. Thus, it is possible to obtain one or more portions of food slices from two different food bars, without shred formation occurring.

FIG. 4 shows a further application form of the method according to the invention. In the present case, a food portion is intended to be sliced, said food portion consisting of six food slices A′, three food slices B′ and one food slice C′. This is achieved in that first of all only the two food bars A and the food bar B are sliced, as illustrated in FIG. 4a, while the food bar C is located in a pulled-back position. The cutting blade consequently does not cut off a slice from all food bars. In the time in which the cutting blade is not engaged with the food bars, the food bar C is pushed forward for the last cutting movement (the last cut) for this portion, and during this last cut (cf. FIG. 4b) slices are cut off from all four food bars. Then, the front end of the food bar C is pulled back out of the cutting plane 6 again and a new portion can be sliced. The pulling back of the food bar C takes place preferably after the cutting blade has been moved away from the cutting plane. As a result, there is a sufficiently long period of time both for transporting the finished food portion away from the slicing device and for pulling back the food bar C. If it is necessary in order to form a portion for all of the food bars to be sliced at the same time, this should take place at least during the last cut for each particular portion, because more time is available thereafter for pulling back the no longer required food bar for the next cut of the next portion. However, the method also functions without the cutting blade being moved out of the cutting plane.

FIG. 5 shows a further application form of the method according to the invention. In the present case, a gripper 9 is arranged per lane, it being possible to bring said gripper 9 into engagement with the rear end 17 of the particular food bar A-C present in the lane, in order to stabilize said food bar A-C, in particular when the slicing thereof has already advanced to a considerable degree, in its position and/or in order to pull back the remaining oddment from the cutting blade. In the present case, all of the grippers 9 are provided on a central unit 15 which is provided to be movable, preferably in the direction of the cutting plane and back, or to be stationary. In relation to this central, unit 15, the grippers 9 can be moved for example independently of one another by a motorized drive. The central unit 15 guides the grippers 9 preferably during their movement in relation to the central unit. The grippers grasp the rear end of the food bar in each case only after the slicing thereof has begun, preferably only once the slicing thereof has virtually been completed. In the exemplary embodiment according to FIG. 5, in order to form a portion, in each case two slices are cut off from the food bars A and B but only one slice is cut off from the food bar C. As a result, the food bar C is sliced more slowly than the food bars A and B.

In the illustration according to FIG. 5, the food bars A and B have been sliced to a comparatively considerable extent, while a long, unsliced portion of the food bar C is still present. Consequently, the grippers 9 which are arranged behind the food bars A and B are moved forward in relation to the central unit 15, in order to come into engagement with the food bars A and B. By contrast, the gripper behind the food bar C remains in a pulled-back position and is not brought into engagement with the food bars. In this state, the slicing of the food bars is continued until the food bars A and B have been sliced completely, apart from an oddment. Then, the remaining oddment of the food bars A and B is pulled back from the respective grippers and preferably discarded via a chute (not illustrated). Next, each gripper is moved preferably into its home position. The lanes which have been emptied in this way can be loaded with a new food bar, as is illustrated in FIG. 5c. These new food bars A and B are then sliced. It can also be seen in FIG. 5c that now the food bar C has been sliced to a considerable extent, and so the gripper located behind it is brought into contact with this food bar, while the grippers 9 which are located behind the food bars A and B are not in engagement therewith.

FIG. 5d shows the state in which all of the rear ends of all of the food bars are each in engagement with a gripper 9.

The example according to FIG. 5 shows that it is possible and sensible to grasp the ends of the food bars at different times. This is possible in particular in that the ends of the food bars are only grasped when the slicing thereof is already underway and/or is virtually finished.

FIG. 6 shows a lane 3′-3″″ of a slicing machine, by way of which the method according to the invention can be carried out. A food bar A, B, C is located on a conveying belt and is transported thereby in the direction of a cutting blade 1. The transport is supported by a second conveying belt 5 resting on the top end of the food bar, said second conveying belt 5 preferably pressing the food bar against the lower conveying belt 5. The conveying belts 5 transport the food bar A, B, C in the direction of the cutting blade 1, which is driven in rotation and exits off a food slice from the front end of the food bar upon each rotary movement, when the cutting blade is located in the cutting plane and the food bar is transported in the direction of the cutting blade. In order to carry out unproductive cuts, the cutting blade is displaced, as illustrated by the arrow, parallel to its rotation axis and for a particular period of time by a linear distance from the food bar and the cutting plane. As soon as unproductive cuts are no longer desired, the blade is moved back along the same path into the cutting plane again. Furthermore, if required, at least the front end 16 of the food bar A, B, C is pulled back from the cutting plane. However, it is also possible to pull back the entire belt structure, including the food bar. Arranged in the region of the rear end 17 is a gripper 9, which, if required, in particular when the food bar has already been sliced to a considerable extent, is brought into engagement therewith. Preferably, the gripper 9 has claws which are brought into connection with the rear end 17 in a form- and/or force-fitting and reversible manner. As soon as the food bar has been largely sliced, such that only an oddment remains, this oddment is pulled back from the cutting plane by the gripper 9 and preferably discarded via a chute (not illustrated).

### LIST OF REFERENCES SIGNS

1 Cutting blade
2 Slicing device
3 Lane
3′-3″″ Lane
4 Cutting plane
5 Transporting means
6 Cutting plane
7 Movement of the cutting blade away from the cutting plane and/or the front end of the food bar
8 Pull-back movement of the front end of the food bar
9 Gripper
10 Table, portioning belt
11 Arrow, movement of the table 10 in the transporting direction of the food bars
12 Arrow, movement of the table 10 transversely to the transporting direction of the food bars
13 Guide means, connecting means
14
15 Central unit of the grippers
16 Front end of the food bar
17 Rear end of the food bar
A, B, C Food bar
A′, B′, C′ Food slice of the food bar A, B, C

1. A method for slicing at least one food bar comprising:
providing a slicing device in which at least one food bar is transported;
transporting the at least one food bar, each in one lane by way of in each case one transporting means in the direction of a rotationally driven cutting blade which cuts off food slices from the food bar in a cutting plane at the front end of the food bar;
combining said food slices into portions; and
transporting said food slices away,
wherein, in order to produce the portion and/or to transport the portions away, the cutting blade carries out unproductive cuts, in which the cutting blade moves but no food slices are cut off from the food bar,
wherein in order to carry out the unproductive cuts, the cutting blade and at least the front end of the food bar are moved away from one another.

2. The method as claimed in claim 1, wherein movement of the cutting blade begins before movement off a front end of a particular food bar.

3. A method for slicing food bars comprising:
providing a slicing device which has multiple lanes, loading a food bar into each of the multiple lanes of the slicing device, and
transporting each of the food bars, independently of the food bars in another lane or lanes, in a direction of a rotationally driven cutting blade which cuts off food slices in a cutting plane at a front end of a particular food bar,
combining said food slices into portions, and
transporting said food slices away,
wherein during cutting movements for slicing a complete portion, a same number of food slices is not cut off for all food bars and/or at least occasionally different food bars are sliced.

4. The method as claimed in claim 3, wherein a number of unproductive cuts for each lane is selected individually.

5. The method as claimed in claim 4, wherein in order to carry out an unproductive cut, the cutting blade and/or at least the front end of the food bar that has just been sliced are moved away from one another.

6. The method as claimed in claim 3, wherein for one portion, food slices are cut off from a plurality of food bars.
wherein a number of food slices per food bar is different, and during the last cutting movement for each particular portion a slice is cut off from all food bars.

7. The method as claimed in claim 1, wherein the food bars are each grasped by a gripper at different times at that end of the food bar that is remote from the front end.

8. The method as claimed in claim 7, wherein for each food bar there remains an unsliced end piece which is pulled back in each case by a gripper and this pull-back takes place in each particular lane at least to some extent at different times.

9. The method as claimed in claim 7, wherein the grippers are all mounted in a movable manner on a central unit.

10. The method as claimed in claim 7, wherein each gripper has a separate drive.

11. The method as claimed in claim 1, wherein a number of unproductive cuts for each lane is selected individually,
wherein a number of food slices per food bar is different, and during the last cutting movement for each particular portion a slice is cut off from all food bars.

12. The method as claimed in claim 4, wherein for one portion, food slices are cut off from a plurality of food bars,
wherein a number of food slices per food bar is different, and during the last cutting movement for each particular portion a slice is cut off from all food bars.

13. The method as claimed in claim 5, wherein for one portion, food slices are cut off from a plurality of food bars,
wherein a number of food slices per food bar is different, and during the last cutting movement for each particular portion a slice is cut off from all food bars.

14. The method as claimed in claim 2, wherein the food fears are each grasped by a gripper at different times at that end of the food bar that is remote from the front end.

15. The method as claimed in claim 3, wherein the food bars are each grasped by a gripper at different times at that end of the food bar that is remote from the front end.

16. The method as claimed in claim 8, wherein the grippes are all mounted in a movable manner on a central unit.

17. The method as claimed in claim 8, wherein each gripper has a separate drive.

18. The method as claimed in claim 9, wherein each gripper has a separate drive.

19. The method as claimed in claim 15, wherein each gripper has a separate drive.

20. The method as claimed in claim 16, wherein each gripper has a separate drive, and
wherein the method includes a step of stabilizing each of the at least one food bars with the gripper.
